(19) United States
(12) Patent Application Publication
(10) Pub. No.: US 2025/0179864 A1
(43) Pub. Date: Jun. 5, 2025

(54) FLOOR BRIDGE, SILL, SLIDING DOOR AND/OR SLIDING WINDOW SYSTEM

(71) Applicant: Salamander Industrie-Produkte GmbH, Türkheim (DE)

(72) Inventor: Till Schmiedeknecht, Munich (DE)

(73) Assignee: Salamander Industrie-Produkte GmbH, Türkheim (DE)

(21) Appl. No.: 18/968,444

(22) Filed: Dec. 4, 2024

(30) Foreign Application Priority Data
Dec. 4, 2023 (DE) 102023133792.0

(51) Int. Cl. E06B 1/64; E06B 3/46

(52) U.S. Cl. CPC E06B 1/64; E06B 3/4609; E06B 3/4636

(57) ABSTRACT

A seal for a sill for a sliding door and/or sliding window system (e.g., a lifting sliding door and/or lifting sliding window system which may include a sash and a sliding or lifting sliding sash, which can be moved in a displacement direction relative to the sash) may include a connecting part with a joint head for (e.g., form-fitting and/or force-fitting) attachment to a lateral end face of the sill extending in the displacement direction, and a sealing part with a sealing lip for sealing with respect to a base or floor, and a joint socket. The joint socket, for coupling the sealing part and the connecting part to one another, may engage around the joint head (e.g., in a form-fitting manner) and, in the coupled state of the sealing part and the connecting part, may be rotated relative to the joint head.

### CROSS REFERENCE TO RELATED APPLICATIONS

This patent application claims priority to German Patent Application No. 10 2023 133 792.0, filed Dec. 4, 2023, which is incorporated herein by reference in its entirety.

### BACKGROUND

### Field

The present disclosure relates to a floor bridge for a sill for a sliding door and/or sliding window system, in particular a lifting sliding door and/or lifting sliding window system, which has a sash, in particular a sliding or lifting sliding sash, and a sliding or lifting sliding sash which is movable in a displacement direction (V) relative to the sash. Furthermore, the present disclosure relates to such a sill for a sliding door and/or sliding window system, in particular a lifting sliding door and/or lifting sliding window system, and a sliding door and/or sliding window system, in particular a lifting sliding door and/or lifting sliding window system.

### Related Art

A sliding window and/or sliding door system generally has at least two window and/or door elements, which are also referred to below as sashes. In such sliding systems, at least one movable sliding sash and at least one further sash, which can also be, for example, a sliding sash or a stationary or fixed sash, are provided. This means that the sliding sash has a displacement device which permits a translational relative displacement with respect to the further sash and with respect to the stationary case frame. In a lifting sliding system, a lifting sliding unit is provided on at least one of the sashes, which lifting sliding unit permits this sash to be lifted and then displaced linearly. Such sashes usually have a sash profile frame which, on a profile frame underside facing the floor or base, has a carriage which is to be placed on a running rail in order to lift the sash and displace it translationally. A running rail is understood to be a sill-side guide of the sliding sash carriage which extends along the entire sill width. For example, at least one carriage pair or at least two separate carriages connected via a connecting rod can be used. After a displacement movement of the sash, the latter can be lowered again, i.e. the carriage is retracted again and further displacement of the sash is prevented. The floor-sided, horizontally extending part of the case frame which comprises the running rail is also referred to as a sill.

One disadvantage is the great vertical height of known sills. These cannot meet the demand for ever lower vertical heights, in particular so-called barrier-free sliding door and/or sliding window systems, in particular lifting sliding door and/or lifting sliding window systems.

A further challenge in the design of sills and the assembly thereof is that the undergrounds or floors on which the sills are placed can vary from the material surface, the stiffness of the material and/or from the height dimensions which produce different interspaces or gaps between the sill and the floor. However, the aim is for the sills to be able to be used irrespective of whether the floor or the base is a natural stone floor, a tile floor, a parquet floor or else marble which has a high movement tolerance, for example.

According to DE 20 2012 001 082 U1, for example, height compensation profiles are used to bridge interspaces between the floor sill and the floor or base. The height compensation profile is of multi-part construction and has a connecting part for attachment to the floor sill, a movable or movable bridging part and a securing part for securing the sealing part to the connecting part. On the one hand, the assembly has proven cumbersome on the height compensation profile according to DE 20 2012 001 082 U1. Furthermore, the possibility of orientation of the height compensation profiles relative to the sill is limited. Either a single predetermined assembly position can be engaged or the height compensation profile can be moved freely, which can lead to it leaving the correct operating position.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a perspective view of an exemplary embodiment of a sill according to the disclosure;

FIG. 2 shows a perspective sectional view of an exemplary embodiment of a sliding door and/or sliding window system according to the disclosure;

FIGS. 3 to 7 shows a mounting process of an exemplary embodiment of a floor bridge according to the disclosure on a sill;

FIG. 8 shows a further exemplary embodiment of a floor bridge according to the disclosure;

FIG. 9 shows an exemplary embodiment of a sliding door and/or sliding window system according to the disclosure;

FIG. 10 shows a further exemplary embodiment of a sill according to the disclosure;

FIG. 11 shows a perspective view of the guide device from FIG. 10;

FIG. 12 shows a further exemplary embodiment of a sill according to the disclosure; and

FIG. 13 shows a perspective view of the guide device from FIG. 12.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

It is an object of the present disclosure to overcome the disadvantages from the conventional techniques, in particular to provide a floor bridge for a sill of a sliding door and/or sliding window system which is simpler to assemble and/or can be used more flexibly.

Accordingly, a floor bridge for a sill for a sliding door and/or sliding window system, in particular a lifting sliding door and/or lifting sliding window system, which has a sash, in particular a sliding or lifting sliding sash, and a sliding or lifting sliding sash which is movable in a displacement direction relative to the other sash, is provided. The floor bridge can also be used in a house door sill, a sill of a revolving door or other door and/or window sills.

Sills can be arranged at the transition between an inner floor of a building interior and an outer floor outside the building and/or generally serve to cover butt joints, to form a lower stop for a door or a window, in order to protect or seal the interior of a house or a dwelling against noise, water and/or draft air. Sliding door or sliding window systems can have a sliding sash and a further sash, which can also be a sliding sash or a stationary or frame fixed sash, whereby the sliding sash can be moved in a displacement direction relative to the further sash. In a sliding system of two sliding sashes, both sliding sashes can each be displaced relative to the other sliding sash. In a lifting sliding door and/or lifting sliding window system, a lifting sliding sash and a further sash, which may be a fixed sash or also a lifting sliding sash, are generally provided. The lifting sliding sash is configured to be movable in a displacement direction relative to the further sash, and furthermore configured to be lifted vertically, in order to then be able to be displaced in the displacement direction. The displacement direction of the sliding sash or lifting sliding sash substantially corresponds to the longitudinal extension direction of the sill. The sill can generally be referred to as the floor-side, substantially horizontally extending part of a case frame of the window or the door. The sill can connect two vertical case frame parts arranged at a distance from each other and/or be arranged between them.

The floor bridge according to the disclosure can in principle be designed to seal the sill with respect to the floor or base and/or to bridge any interspaces or a gap between the floor and sill, if appropriate with a height offset. The floor bridge may comprise a connecting part with a joint head for attachment, in particular in a form-fitting and/or force-fitting manner, to a lateral end face of the sill extending in the displacement direction. Furthermore, the floor bridge may comprise a bridging part with a bridging lip for bridging an interspace between the base or floor and sill and a joint socket, which for coupling the bridging part and connecting part to each other encompasses the joint head, in particular in a form-fitting manner, and in the coupled state of the bridging part is rotatable relative to the joint head. On an underside of the bridging part facing the floor, a seal, for example in the form of a sealing tape or a synthetic polymer, such as a surface-crosslinked plastic (e.g., silicone) can be arranged, for example, in a fillet. A particularly simple assembly of the floor bridge to the sill is thereby possible. In particular, the assembly takes place in two stages. This means that firstly the connecting part is mounted, in particular plugged, clipped or latched, onto the sill, and subsequently the bridging part is again mounted, in particular plugged, pushed or clipped, onto the connecting part. As a result of the relative rotation possibility of the joint socket with respect to the joint head, the floor bridge can be used very flexibly and can be adapted to different circumstances, that is to say in particular height differences between the sill and base or floor which are to be bridged or compensated for. The advantageous assembly is supported by the plugged-on and encompassing of the joint head by means of the joint socket. For example, in the coupled state of the bridging part and connecting part, a rotation angle of up to 150°, in particular of up to 125° or 100°, is given. The bridging lip and the joint socket can be produced from one piece, in particular from metal, such as aluminum. Furthermore, the connecting part can also be produced from one piece. For example, the joint socket and the joint head are constructed in the manner of a hinge joint, whereby in particular the joint head can have a roller-shaped or full cylindrical shape, which rests in a tongs-shaped manner in a channel-like joint socket, which corresponds to a segment of a hollow cylinder. The joint head, which rests during the relative rotation of the joint socket with respect to the joint head, can provide a bearing surface, in particular plain bearing surface, of more than 190°, in particular of more than 235° or more than 270°.

In an exemplary embodiment of the floor bridge according to the disclosure, the joint head and the joint socket are matched to one another in such a way that the joint socket slides along the joint head during a relative rotation movement. Alternatively, or additionally, the joint socket and the joint head can be matched to one another in such a way that the joint socket is guided by the joint head in a relative rotation movement. In an exemplary further development, the arrangement, in particular matching of the joint socket and joint head to one another, ensures on the one hand the fastening of the bridging part and connecting part to each other and on the other hand the relative movement, in particular relative rotation, of the connecting part and bridging part. As a result of the functional union thus given, the floor bridge is particularly simple in construction and easy to operate.

According to a further aspect of the present disclosure, which can be combined with the previous aspects and exemplary embodiments, a floor bridge for a sill for a sliding door and/or sliding window system, in particular a lifting sliding door and/or lifting sliding window system, is provided. The floor bridge can also be used in a house door sill, a sill of a revolving door or other door and/or window sills.

Accordingly, a floor bridge for a sill for a sliding door and/or sliding window system, in particular a lifting sliding door and/or lifting sliding window system, which has a sash, in particular a sliding or lifting sliding sash, and a sliding or lifting sliding sash which is movable in a displacement direction relative to the other sash, is provided.

Sills can be arranged at the transition between an inner floor of a building interior and an outer floor outside the building and/or generally serve to cover butt joints, to form a lower stop for a door or a window, in order to protect or seal the interior of a house or a dwelling against noise, water and/or draft air. Sliding door or sliding window systems can have a sliding sash and a further sash, which can also be a sliding sash or a stationary or frame fixed sash, whereby the sliding sash can be moved in a displacement direction relative to the further sash. In a sliding system of two sliding sashes, both sliding sashes can each be displaced relative to the other sliding sash. In a lifting sliding door and/or lifting sliding window system, a lifting sliding sash and a further sash, which may be a fixed sash or also a lifting sliding sash, are generally provided. The lifting sliding sash is configured to be movable in a displacement direction relative to the further sash, and furthermore configured to be lifted vertically, in order to then be able to be displaced in the displacement direction. The displacement direction of the sliding sash or lifting sliding sash substantially corresponds to the longitudinal extension direction of the sill. The sill can generally be referred to as the floor-side, substantially horizontally extending part of a case frame of the window or the door. The sill can connect two vertical case frame parts arranged at a distance from each other and/or be arranged between them.

The floor bridge according to the disclosure may comprise a connecting part with a joint head for attachment, in particular in a form-fitting and/or force-fitting manner, to a lateral end face of the sill extending in the displacement direction. Furthermore, the floor bridge may comprise a bridging part with a bridging lip for bridging an interspace between the base or floor and sill and a joint socket, which for coupling the bridging part and connecting part to each other can be brought into engagement with the joint head.

According to the further aspect of the present disclosure, the joint socket for coupling the bridging part and connecting part to each other can be brought into engagement with the joint head. Furthermore, in the coupled state of the bridging part and connecting part, the joint socket is rotatable relative to the joint head between two end rotation stops.

A particularly simple assembly of the floor bridge to the sill is thereby possible. In particular, the assembly takes place in two stages. This means that firstly the connecting part is mounted, in particular plugged, clipped or latched, onto the sill, and subsequently the bridging part is again mounted, in particular plugged, pushed or clipped, onto the connecting part. As a result of the relative rotation possibility of the joint socket with respect to the joint head, the floor bridge can be used very flexibly and can be adapted to different circumstances, that is to say in particular height differences between the sill and base or floor which are to be bridged or compensated for. For example, in the coupled state of the bridging part and connecting part, a rotation angle of up to 150°, in particular of up to 125° or 100°, is given. The bridging lip and the joint socket can be produced from one piece, in particular from metal, such as aluminum. Furthermore, the connecting part can also be produced from one piece. For example, the joint socket and the joint head are constructed in the manner of a hinge joint, whereby in particular the joint head can have a roller-shaped or full cylindrical shape, which rests in a tongs-shaped manner in a channel-like joint socket, which corresponds to a segment of a hollow cylinder. The joint head, which rests during the relative rotation of the joint socket with respect to the joint head, can provide a bearing surface, in particular plain bearing surface, of more than 190°, in particular of more than 235° or more than 270°.

The provision of two end rotation stops, whereby, in particular, one end rotation stop is responsible for one rotation direction and the other rotation stop for the opposite rotation direction, fulfills several functions. On the one hand, they define final assembly positions, so that a faulty operation or assembly position, for example in which an undesired disassembly of the connecting part and bridging part would occur, can be avoided. Furthermore, the end rotation stops, when adopting the end rotation positions, support the fact that the bridging part remains in the respective position relative to the connecting part.

According to an exemplary further development of the floor bridge according to the disclosure, a rotation angle defined by the two end rotation stops is at least 60°, in particular at least 70°, 80° or at least 90°, preferably up to 100°. The angle defines the movement clearance of the bridging part relative to the connecting part.

In a further exemplary embodiment of the floor bridge according to the disclosure, the two end rotation stops are formed by two pairs of mutually associated stop surfaces of the connecting part and bridging part. In other words, the connecting part and bridging part each have two stop surfaces, whereby in each case one stop surface of the connecting part and bridging part comes into a stop contact when adopting the end rotation position defined by the respective end rotation stop.

In a further exemplary further development of the floor bridge according to the disclosure, the joint head is C-shaped in cross-section and has a projection on both C-legs. The projections are designed for striking in each case a bearing web forming the joint socket in sections. As a result of the fact that the components or structures forming the end rotation stops are each formed from one piece with the bridging part or bearing part, a floor bridge which is particularly simple in construction is provided. The projections on the C-legs extend from the C-legs in such a way that they extend counter to the circumferential direction or main extension direction of the C-legs. For example, the bearing webs have a concave receiving surface facing the joint head and/or a substantially thin-walled web against which the projections of the C-legs can strike.

In a further exemplary embodiment of the present disclosure, the joint head is substantially cylindrical, in particular substantially full cylindrical, or roller-shaped. For example, the connecting part furthermore has a web which can be placed flush on an upper side of the sill and which opens into the joint head. The web can form a substantially planar surface.

In particular, the joint head is formed from one piece with the floor piece. For example, the web forms one of the two end rotation stops on the connecting part side. In a further exemplary embodiment of the present disclosure, the joint socket has a concave receptacle for the joint head. For example, the receptacle is of circular arc-shaped design. Alternatively, or additionally, a central angle is more than 180°. As a result of the consequently resulting encompassing of the joint head by more than 180°, the bridging part does not require a separate fastening device in order to remain arranged or fixed on the connecting part. The angle in combination with the conformal matching of the joint head and joint socket to one another permits on the one hand the relative rotation and on the other hand the fastening of the bridging part and connecting part to each other.

According to an exemplary further development of the floor bridge according to the disclosure, the joint socket-side stop surfaces are formed by the opposite ends of the concave receptacle, in particular of the circular arc. The joint socket can have, for example, a C-shaped shape. In this case, the end faces of the C-structure can each form the stop surfaces which can come into a stop contact with the respective stop surfaces on the connecting part in order to form the end rotation stops.

According to a further exemplary embodiment of the present disclosure, the connecting part has two latching elements, such as two latching projections, which are designed to be brought into engagement with a respective sill-side latching element, such as a latching recess, in order to attach the connecting part to the sill. A latching element can be formed on the web, in particular be produced from one piece therewith. In this way, an assembly of the connecting part to the sill which is particularly easy to carry out can take place. For example, one of the latching elements serves to place the connecting part on the sill in a positionally fixed manner. The other connecting part latching element can serve for the ultimate fastening of the connecting part to the sill, in which the connecting part placed on the sill by means of the first latching element is finally brought into the further engagement with the sill via the further latching element.

In an exemplary further development of the floor bridge according to the disclosure, a connecting part-side latching element, in particular an upper latching element, is designed as an in particular roller-shaped joint head and/or can be engaged around or is engaged around in the manner of pliers by the associated sill-side, in particular inner-shaped latching element designed as a joint socket, in particular a latching element arranged on an upper side of the sill. For example, the latching element pairs form a hinge joint. In this case, the connecting part-side latching element can be placed on the sill in an assembly orientation and can be brought into the assembly position by means of the interaction with the sill-side latching element. For example, in the assembly position, the engagement of the further latching element pair then takes place in order to fasten the connecting part at the point.

According to a further exemplary embodiment of the floor bridge according to the disclosure, a connecting part-side latching element, in particular a lower latching element, is designed to engage behind a sill-side profile web in a transverse direction oriented transversely to the displacement direction, in particular in order to avoid a mutual removal of the connecting part and sill in the transverse direction. For example, the latching element pair interacts with each other in the manner of a latching or clipping mechanism.

According to a further aspect of the present disclosure, which can be combined with the previous aspects and exemplary embodiments, a sill, in particular for a sliding door and/or sliding window system, in particular a lifting sliding door and/or lifting sliding window system, which has a sash, in particular a sliding or lifting sliding sash, and a sliding or lifting sliding sash which is movable in a displacement direction relative to the other sash, is provided.

The sill according to the disclosure may comprise a lateral end face extending in the displacement direction. The lateral end face can be designed to be substantially planar at least in sections and/or can be oriented transversely, in particular perpendicularly, to a sill floor surface defining the upper side.

The sill according to the disclosure further may comprise a floor bridge according to the disclosure, which can be designed according to one of the previously described aspects or one of the previously described exemplary embodiments and the connecting part of which is attached, in particular in a form-fitting and/or force-fitting manner, to the end face and the bridging part of which is in engagement with the connecting part.

According to a further aspect of the present disclosure, which can be combined with the previous aspects and exemplary embodiments, a sliding door and/or sliding window system, in particular a lifting sliding door and/or lifting sliding window system, is provided. The sliding system or the lifting sliding system can comprise a sliding sash or a lifting sliding sash, which is produced, for example, from plastic, and also a further sash, which may be produced from plastic and can be a fixed sash, a sliding sash or a lifting sliding sash.

The sliding door and/or sliding window system according to the disclosure may comprise a sliding or lifting sliding sash, such as from plastic, which may be produced in the plastic extrusion process, and a further sash, such as from plastic, which can also be produced in the extrusion process, in particular a sliding or lifting sliding sash. The sliding or lifting sliding sash is movable in a displacement direction relative to the further sash. If both sashes are movable or displaceable, they can each be displaced in the displacement direction relative to the other.

The sliding door and/or sliding window system according to the disclosure also may comprise a sill, which is designed in particular according to the disclosure and has a running rail groove and a guide device, such as a running rail, which is accommodated completely in the running rail groove and is designed to move the sliding or lifting sliding sash into guide engagement with a running carriage. As a result of the fact that the guide device is accommodated completely in the running rail groove, or in other words does not project beyond the running rail groove or out of the running rail groove in the vertical direction, the sliding door and sliding window system according to the disclosure is designed particularly advantageously to meet today's requirements and endeavors to create barrier-free transitions between building rooms or between a building room and the surroundings. Furthermore, it is possible to be able to seal the interface to be sealed between the sliding or lifting sliding sash and the sill more effectively or in a simpler manner, since the interface is reduced in size compared to prior art embodiments.

According to a further aspect of the present disclosure, which can be combined with the previous aspects and exemplary embodiments, a sliding door or sliding window system, in particular a lifting sliding door and/or lifting sliding window system, is provided, which can be designed according to one of the previously described aspects, for example exemplary embodiments.

The sliding door and/or sliding window system according to the disclosure may comprise a sliding or lifting sliding sash, such as from plastic, which may be produced in the plastic extrusion process, and a further sash, such as from plastic, which can also be produced in the extrusion process, in particular a sliding or lifting sliding sash. The sliding or lifting sliding sash is movable in a displacement direction relative to the further sash. If both sashes are movable or displaceable, they can each be moved in the displacement direction relative to the other.

The sliding door and/or sliding window system according to the disclosure also may comprise a sill, which is designed in particular according to the disclosure and has a running rail groove and a guide device, such as a running rail, which is arranged therein, in particular accommodated completely therein, and is designed to move the sliding or lifting sliding sash into guide engagement with a running carriage.

According to the further aspect according to the disclosure, the guide device may comprise a latching part for connection in a form-fitting and/or force-fitting manner to a latching element of the sill, which latching element corresponds in particular in shape. The assembly of the sliding door and/or sliding window system is thereby possible in a particularly simple manner. The latching offers the advantage, on the one hand, that a defined assembly is also possible for untrained assembly personnel. On the other hand, the latching ensures that the guide device adopts the correct position or orientation in the running rail groove, in particular in order to ensure a reliable displacement of the sliding or lifting sliding sash.

In an exemplary further development of the sliding door and/or sliding window system according to the disclosure, the sill-side latching element is designed as a groove which is T-shaped in cross-section, and the guide device-side latching part has at least one latching projection, in particular two latching projections, which engages behind a T-leg of the groove, in particular is latched or clipped thereto. As a result of the latching parts engaging behind one another, the guide device is positioned in the running rail groove in a positionally secure manner.

In an exemplary further development of the present disclosure, the guide device-side latching part is dimensioned, in particular over-dimensioned, in relation to the sill-side latching element in such a way that the guide device-side latching part is elastically deformed when adopting the assembly end position. For example, the elastic deformation can be cancelled again in the assembly end position. Alternatively, it is possible that a certain elastic deformation is still present even in the assembly end position, so that an elastic deformation restoring force is built up, which reinforces the fastening of the guide device and sill to each other.

According to a further aspect of the present disclosure, which can be combined with the previous aspects and exemplary embodiments, a sliding door or sliding window system, in particular a lifting sliding door and/or lifting sliding window system, is provided, which can be designed according to one of the previously described aspects, for example exemplary embodiments.

The sliding door and/or sliding window system according to the disclosure may comprise a sliding or lifting sliding sash, such as from plastic, which may be produced in the plastic extrusion process, and a further sash, such as from plastic, which can also be produced in the extrusion process, in particular a sliding or lifting sliding sash. The sliding or lifting sliding sash is movable in a displacement direction relative to the further sash. If both sashes are movable or displaceable, they can each be moved in the displacement direction relative to the other.

The sliding door and/or sliding window system according to the disclosure also may comprise a sill, which is designed in particular according to the disclosure and has a running rail groove and a guide device, such as a running rail, which is arranged therein, in particular accommodated completely therein, and is designed to move the sliding or lifting sliding sash into guide engagement with a running carriage.

According to the further aspect according to the disclosure, the guide device may comprise a base resting on a groove base and at least one support arm projecting from the base, in particular two lateral support arms, which are designed in particular identically and/or mirror-inverted and which are dimensioned for flush connection to a sill upper side. As a result, a tiny, in particular step-free and/or moisture-sealed transition can be formed between the guide device and the sill. Furthermore, a groove in the sill can be avoided, which entails the risk of dirt or moisture getting in or people injuring themselves or stumbling.

According to an exemplary embodiment, the support arm bears sealingly against a side wall of the running rail groove, in particular the support arm is pressed against the side wall. As a result, particularly good protection against the penetration of dirt or moisture is given.

According to a further aspect of the present disclosure, which can be combined with the previous aspects and exemplary embodiments, a method for mounting a floor bridge, which is designed in particular according to one of the previous aspects and exemplary embodiments, on a sill, which is designed in particular according to the disclosure, for a sliding door and/or sliding window system, in particular a lifting sliding door and/or lifting sliding window system, with a sliding or lifting sliding sash and a further sash, in particular a sliding or lifting sliding sash, whereby the sliding or lifting sliding sash is movable in a displacement direction relative to the further sash, is provided. The features and embodiments disclosed above with respect to the aspects according to the disclosure with respect to the floor bridge, the sill and the sliding door and/or sliding window system apply analogously to the mounting method according to the disclosure.

According to the method, a connecting part of the floor bridge is plugged in a plug-on direction onto a lateral end face of the sill extending in the displacement direction. The plug-on direction can be oriented in the range from 15° to 45°, in particular by approximately 30°, with respect to the planar extent of the sill, in particular with respect to the horizontal. Furthermore, a bridging part of the floor bridge is brought into a coupling engagement with the connecting part in a coupling orientation along a coupling direction. The connecting part thus assumes a pre-mounted state with the bridging part. Furthermore, the bridging part is rotated about a rotation axis defined by the coupling engagement into a bridging orientation for bridging an interspace between the base or floor and sill. In the bridging orientation, the bridging part is fixedly mounted on the connecting part. Here, a few degrees of rotation are sufficient until self-locking of the parts is involved, which prevents the bridging part and connecting part from moving away from one another. A significant advantage is the simple, tool-free assembly and disassembly of the floor bridge. Disassembly can be carried out with the reverse sequence of the method steps.

According to an exemplary further development of the mounting method according to the disclosure, the connecting part is latched thereto when being plugged onto the sill. As a result, the connecting part is securely arranged and held on the sill.

According to a further aspect of the present disclosure, which can be combined with the preceding aspects and exemplary embodiments, a floor bridge for a sill for a sliding door and/or sliding window system, in particular a lifting sliding door and/or lifting sliding window system, is provided, which may comprise a sash, in particular a sliding or lifting sliding sash, and a sliding or lifting sliding sash, which is movable in a sliding direction (V) relative to the sash.

The floor bridge may comprise a connecting part with a joint head for in particular form-fitting and/or force-fitting attachment to a lateral end face of the sill extending in the sliding direction and a bridging part with a bridging lip for bridging an intermediate space between the base or floor and sill and a joint socket, which can be brought into engagement with the joint head for coupling the bridging part and the connecting part to one another.

According to this aspect according to the disclosure, the floor bridge may comprise exclusively the connecting part and the bridging part. In other words, the floor bridge is formed out of two parts.

Furthermore, the floor bridge can be configured such that it can be connected to the sill without additional fastening devices, such as screws or the like. The floor bridge can be plugged on, latched on and/or clipped on. For example, the assembly and/or the disassembly of the floor bridge, in particular of the connecting part and/or of the bridging part, can take place without tools.

According to a further aspect of the present disclosure, which can be combined with the preceding aspects and exemplary embodiments, the floor bridge is configured such that it forms a barrier-free transition between the base or floor and sill. The connecting part and/or the bridging part can be configured such that they form a flush, in particular step-free, transition to the base or floor or sill.

In the following description of exemplary embodiments of the present disclosure, a floor bridge according to the disclosure, which is intended for use on a sill for a sliding door and/or sliding window system, is generally provided with the reference number 1. A sill according to the disclosure is generally provided with the reference number 10 and a sliding door and/or sliding window system according to the disclosure is provided with the reference number 100. The sill 10 can have any desired structural height and can be produced from any desired material, such as wood, plastic or aluminum. If reference is made to door and/or window profiles in the following description, it can be assumed that these are plastic profiles produced in the extrusion process, in particular from PVC, which have an extrusion direction in which they have a constant cross-section.

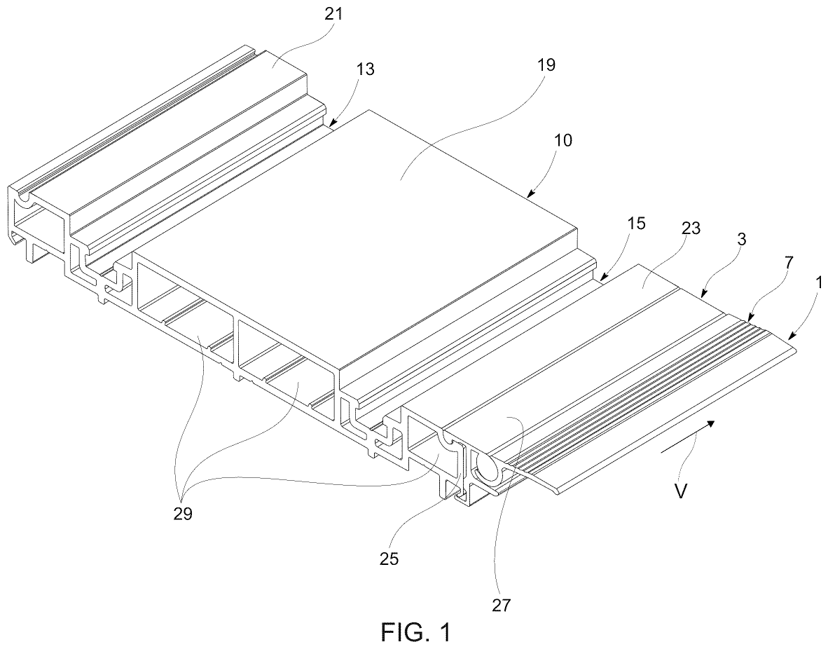

FIG. 1 shows a perspective sectional view of a sill 10 according to the disclosure, to which a floor bridge 1 according to the disclosure is attached. The sill 10 may comprise two running rail grooves 13, 15 which extend in a displacement direction V and are each intended for receiving a guide device, such as a running rail, with which a running carriage 103 of a sliding and/or lifting sliding sash 105 can be brought into engagement and cooperates therewith in order to displace the sliding or lifting sliding sash 105 in the displacement direction V. The sill 10 has a substantially constant cross-section along its longitudinal extension in the displacement direction V. In a central region, the sill 10 may comprise a planar sill surface 19 and two lateral surfaces 21, 23 which each adjoin one of the running rail grooves 13, 15.

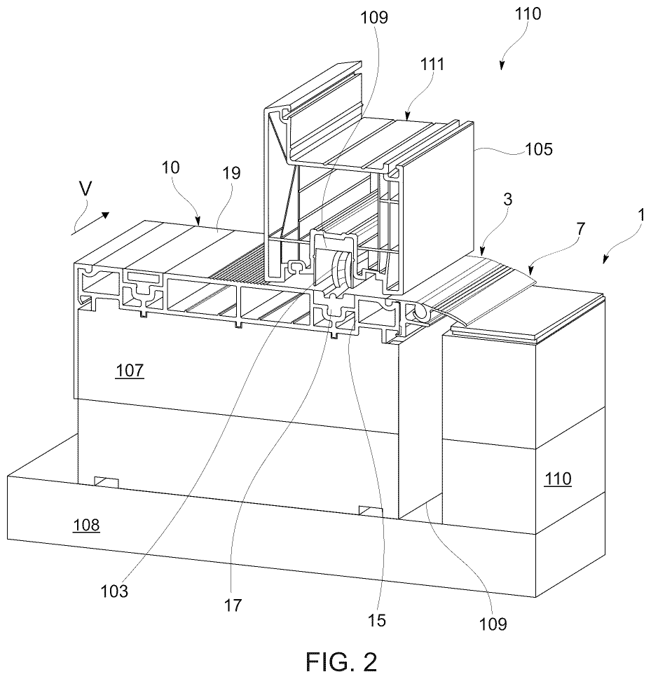

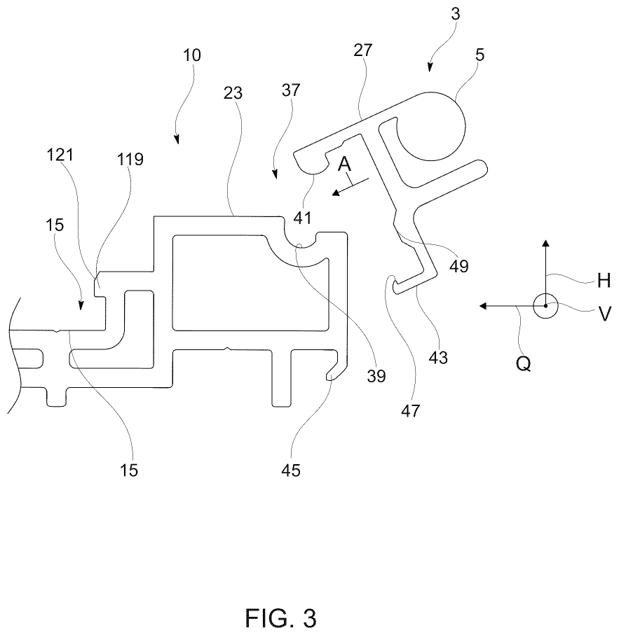

As can be seen, for example, in FIG. 1, the floor bridge 1 is mounted on a lateral end face 25 of the sill 10. The attachment or the arrangement of the floor bridge 1 on the sill 10 takes place here in such a way that the lateral sill surface 23 terminates flush with the floor bridge 21, or adjoins the latter flush therewith, so that a web 27 forming on the upper side of the floor bridge 1 substantially forms a direct extension of the sill surface 23. As can furthermore be seen in FIGS. 2 and 3, the sill 10 may comprise a plurality of hollow chambers 29 which extend in the displacement direction V and which can either be unoccupied or can be used for receiving reinforcing parts.

Referring to FIG. 2, in which an exemplary embodiment of a sliding door and/or sliding window system 100 according to the disclosure is shown, the sill 10 lies on a base 108 by means of a substructure profile 107 which is constructed, for example, in two parts, and the floor bridge 1 bridges an interspace 109 resulting between the sill 10 and a floor covering 108 constructed on a screed 110, in order to bridge the latter in particular in a sealing manner. In FIG. 2, the running rail groove 13 facing away from the floor bridge is occupied by a blind profile 19 which is arranged in a latching manner in the running rail groove 13 and produces a planar and flush transition with adjacent surfaces 19, 21 of the sill, so that a continuous upper side or surface is formed. In the region of the further groove 15 close to the floor bridge, a guide device, which is designed as a running rail 17, is arranged for the sliding and/or lifting sliding sash 105 which can thus be displaced. For this purpose, the sliding and/or lifting sliding sash 105 has a running carriage 103 arranged in a guide groove 112 present on an underside of the sliding and/or lifting sliding sash 105. The sliding and/or lifting sliding sash 105 furthermore has a sash rebate 111, which is arranged on an upper side, for receiving glazing.

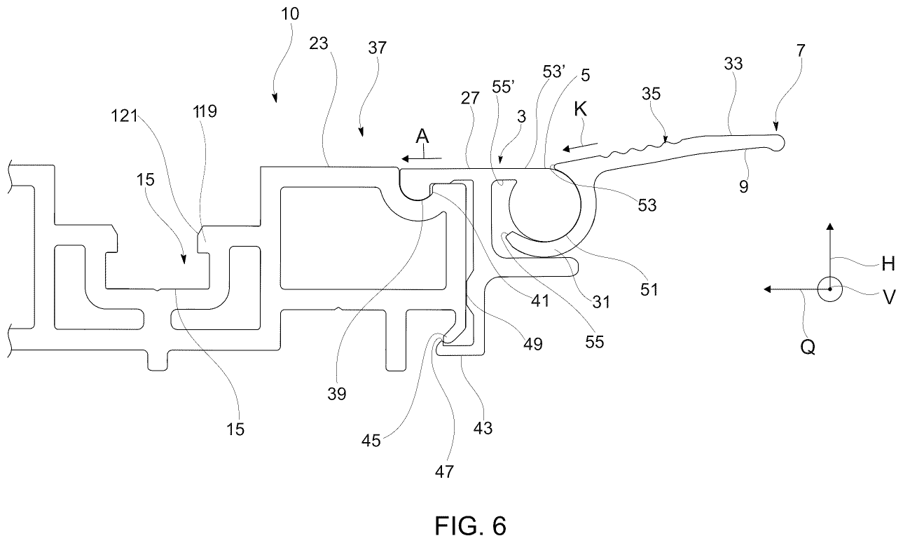

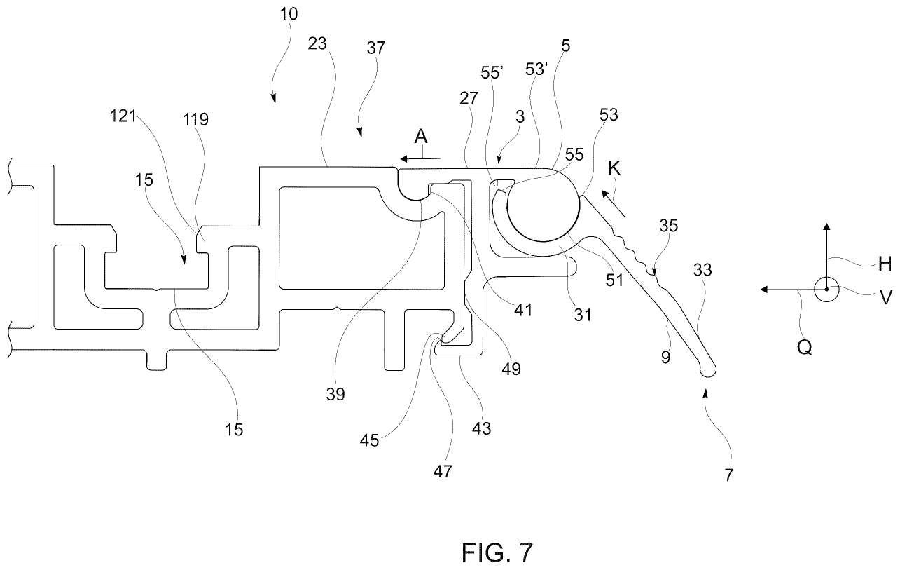

Exemplary embodiments of floor bridges 1 according to the disclosure and their advantageous mounting process with respect to the sill 10 will be explained in more detail with reference to FIGS. 3 to 8. Firstly, with reference to FIG. 6 or 7, the mounted state of the floor bridge 1 on the sill 10 is shown in two different operating positions. The floor bridge 1 may comprise a connecting part 3 with a joint head 5 for attachment to the end face 25 of the sill 10 and a bridging part 7, which can be coupled to the connecting part 3, with a bridging lip 9 and a joint socket 31 for coupling the bridging part 7 and connecting part 3 to each other. The bridging lip 9, which extends schematically over the interspace 109 (FIG. 2), can have, on its upper side 13 facing the surroundings, a structuring 15 which can extend, for example, parallel to the displacement direction V.

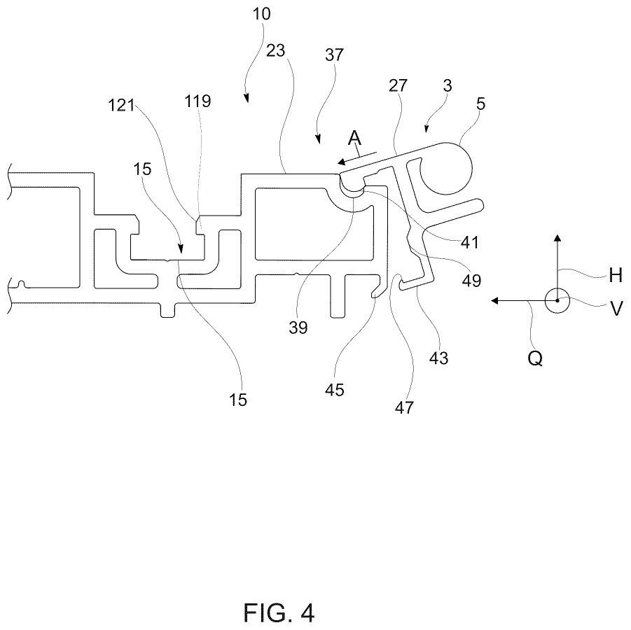

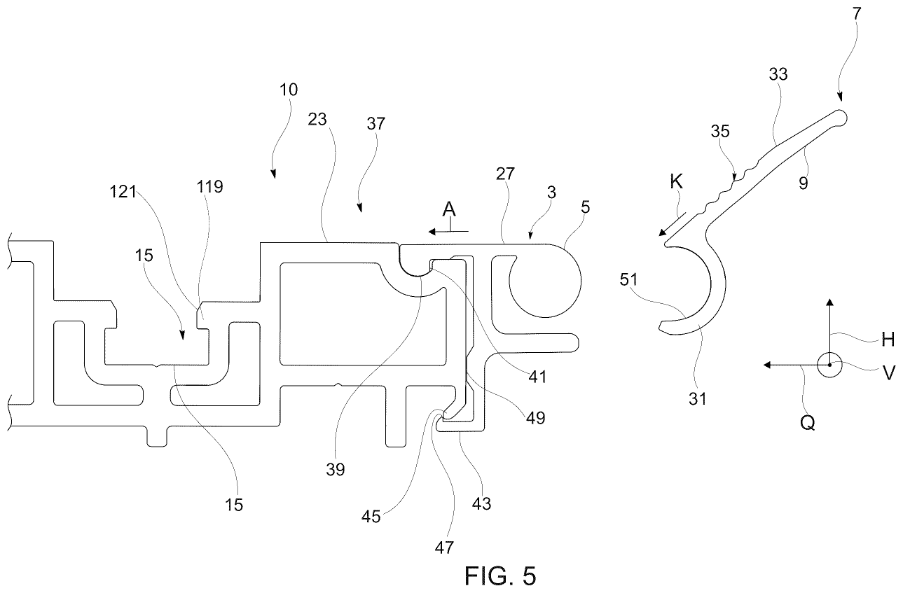

FIG. 3 shows a pre-mounted state, in which firstly the connecting part 3 is plugged in a plug-on direction A onto the lateral end face 25 of the sill 10 (FIG. 3). The plug-on direction A is inclined with respect to a transverse direction Q extending transversely, in particular perpendicularly, to the displacement direction V. In other words, the connecting part 3 is placed obliquely on the lateral end face 25. In this case, a latching and jointing mechanism 37 is used which has a sill-side latching part in the form of a concave groove 39 and a connecting part-side latching element in the form of a convex projection 41. When placing the connecting part 3 on the sill 10, accordingly, firstly the latching and jointing projection 41 is positioned in the latching and jointing depression 39 (FIG. 4) and, using the latching and jointing mechanism 37, is rotated about the displacement direction V and brought into latching engagement with the sill 10 (FIG. 5). The connecting part-side latching and jointing element 41 is designed as a roller-shaped joint head and, together with the sill-side, channel-shaped latching element designed as a joint socket, forms a hinge joint. For latching and positionally secure holding of the connecting part 3 on the sill 10, the connecting part 3 has a further latching element which is arranged on an underside 43 of the connecting part and is designed to engage behind a sill-side profile web 45 of the sill 10. In the mounted state according to FIG. 5, the connecting part 47 engages behind the profile web 45 of the sill 10 in the transverse direction Q, so that a mutual removal of the sill 10 and connecting part 3 in the transverse direction Q is prevented. The connecting part 3 bears in a defined and planar manner on the end face 25 of the sill 10 by means of a bearing projection 49. When latching the connecting part 3 onto the sill 10, that is to say during the transition from FIG. 4 to FIG. 5, the jointing and latching part 41 slides or latches completely into the sill-side corresponding latching element 39.

Finally, the bridging part 7 is pushed onto the connecting part in a coupling orientation along a coupling direction K which is inclined with respect to the transverse direction Q and is brought into a coupling engagement therewith (FIG. 5). For adopting an operating position of the floor bridge, the bridging part 7 is rotated about a rotation axis defined by the coupling engagement into a bridging orientation for bringing into contact with the base or the floor 107 (cf. FIGS. 6 and 7).

The cylindrical or roller-shaped joint head 5 and the sickle-shaped or channel-like joint socket 31 interact in the manner of a hinge joint, in that the joint head 5 is received in a receptacle 51 formed by the joint socket 31 and is rotatable relative to each other in the coupling engagement, in order to rotate the bridging part 7 relative to the connecting part 5. The connecting part 3 and the bridging part 7 are matched to one another to form two end rotation stops, between which the bridging part 7 is rotatable relative to the connecting part 3. The end rotation stops are formed by two pairs of mutually associated stop surfaces 53, 53′ and 55, 55′. An end rotation position is shown in FIG. 7, in which the stop surfaces 55, 55′ are in stop contact with each other and further rotation of the bridging part 7 in the clockwise direction relative to the connecting part 3 is prevented. The other rotation stop is formed by the impact of the bridging part-side stop surface 53 on the connecting part-side stop surface 53′ formed by the web 27, when the bridging part 7 is rotated counterclockwise relative to the connecting part 3.

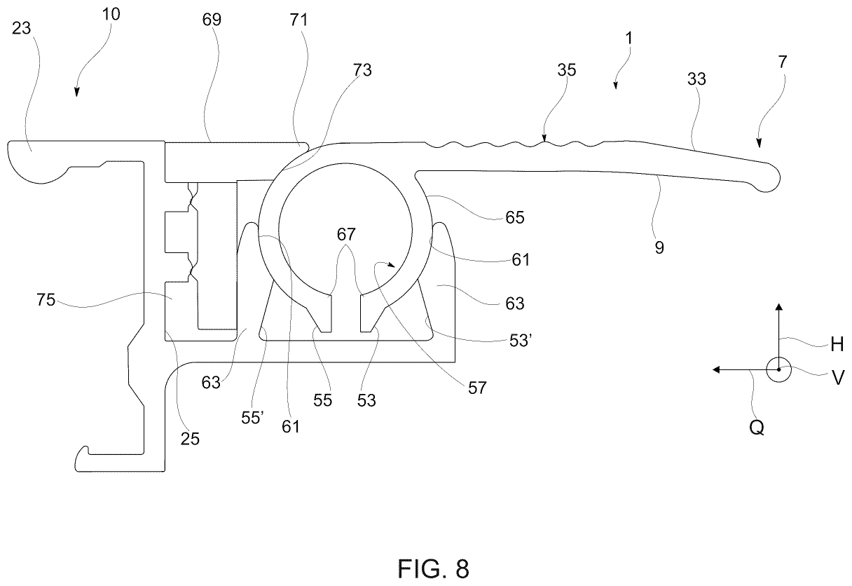

FIG. 8 shows a further exemplary embodiment of a floor bridge 1 according to the disclosure and an associated sill 10. The embodiment of the floor bridge 7 from FIG. 8 differs from the previous embodiment of the floor bridge 1 on the one hand in that the separate connecting part 3 of the floor bridge is omitted or is formed by the sill 10, which for receiving the bridging part 7 with the bridging lip 9 may comprise a rotary bearing receptacle 57, which is formed by two profile webs 63 of the sill 10 forming a concave receptacle and bearing surface 61.

The bridging part 7 has a C-shaped bearing ring 65 matched thereto, which rests on the bearing webs 63 and is rotatable relative thereto, in order to be able to adopt different positions for the bridging lip 9. The two end rotation stops are formed by the bearing webs 63, which have the respective inwardly facing stop surfaces 53′ and 55′, and by in each case one projection 67 projecting on one of the C-legs, which has the stop surfaces 53, 55. The sill 10 or the bridging part 7 according to FIG. 8 furthermore has a securing part 69, which is designed, for example, in the manner of a hammer and has a securing projection 71 with a bearing surface 73 matched to the convex shape of the ring 65, in order to ensure the relative rotation. The securing part 69 is pushed into a receiving groove 75 formed between the lateral end face 25 and the bearing web 63 facing the latter and is clamped or latched therein, in order to hold the bridging part 7 in position or to avoid an undesired disassembly of the bridging part 7.

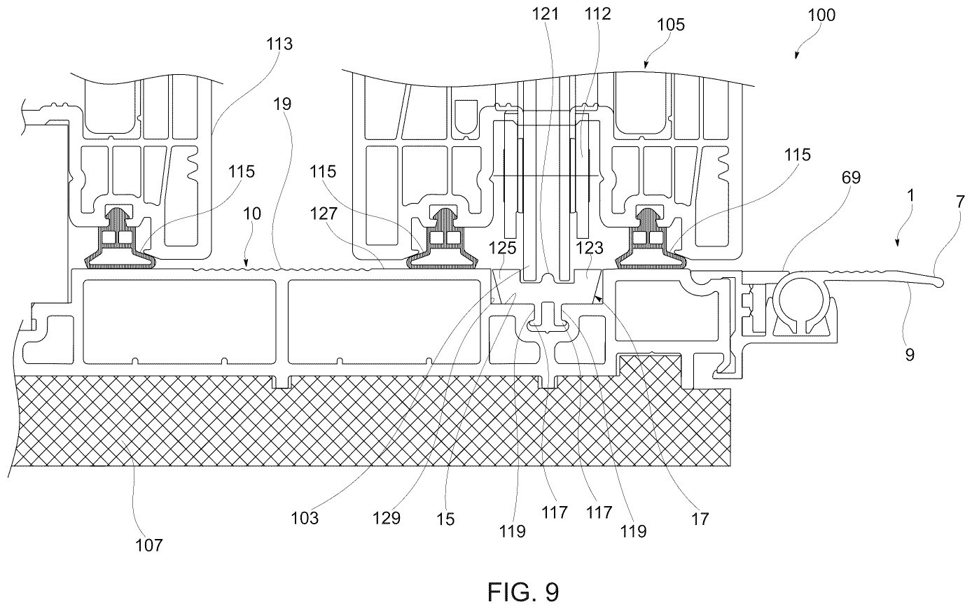

A further aspect of the present disclosure emerges when FIGS. 3 and 9 are considered together. FIG. 9 shows an embodiment of a sliding door and/or sliding window system 100 according to the disclosure by way of example with the floor bridge 1 according to FIG. 8. The system 100 may comprise, in addition to the sliding and/or lifting sliding sash 105, a further sash 113, which can be fixed sashes, for example, which are each sealed with respect to the surface 19 of the sill 10 by means of seals 115. The running rail 17 may comprise two latching arms or latching feet 117 which extend downward counter to the height direction H and are designed to latch and engage behind corresponding sill-side latching projections 119, in order to fix the running rail 17 in the running rail groove 15 in a positionally secure manner.

For simple assembly, the latching projections 119 are slightly beveled. As can be seen in FIG. 9, the guide device 17 does not project beyond the extent of the running rail groove in the height direction H, but terminates maximally flush therewith, so that there is no barrier, for example for wheelchair users, in the region of the running rail. This is also achieved, for example, in that a guide lug 121 is countersunk in the running rail 17 and does not project beyond adjacent limbs of the running rail 17 in the height direction H.

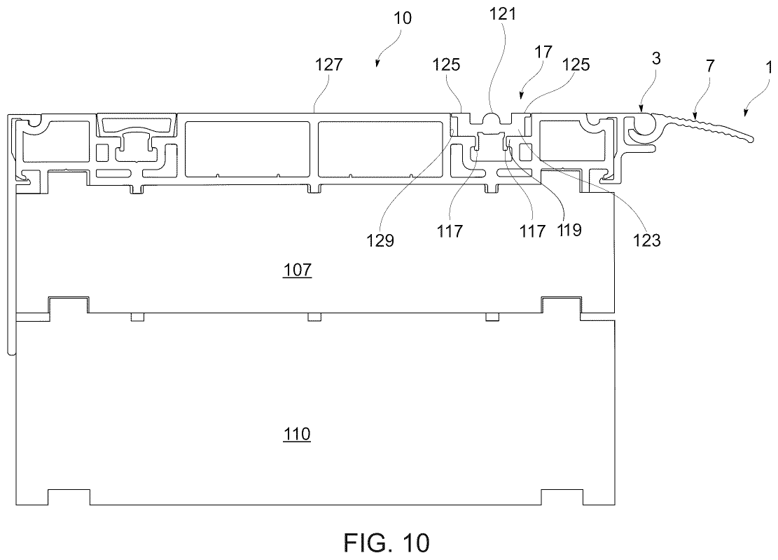

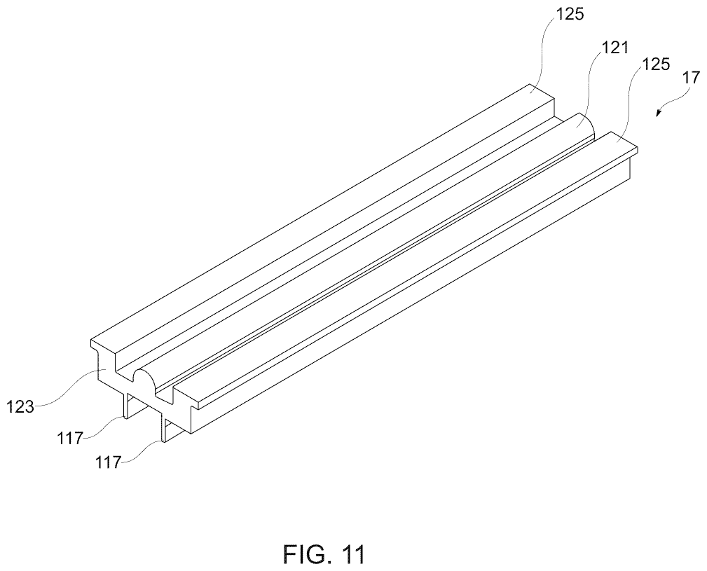

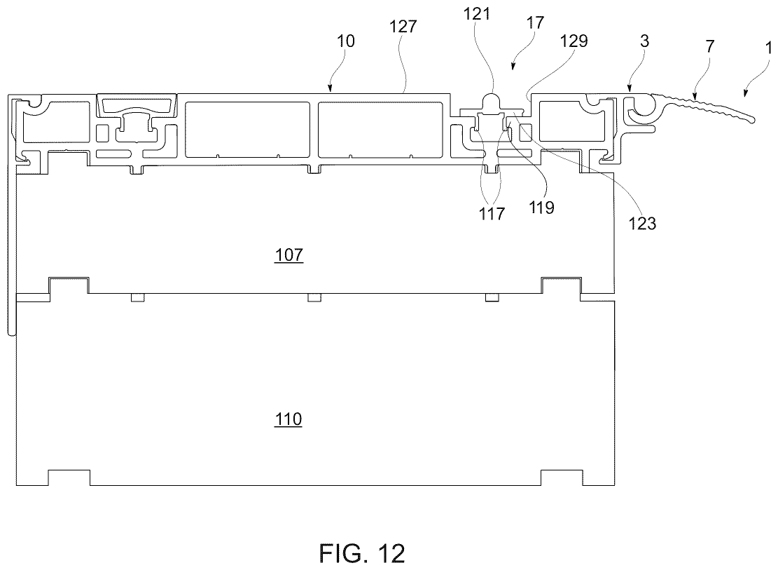

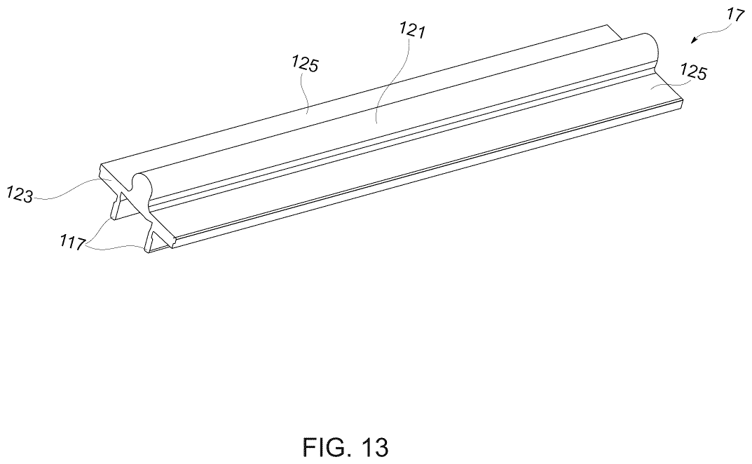

FIGS. 10 and 12 show exemplary embodiments of sills 10 according to the disclosure with exemplary embodiments of floor bridges 1 according to the disclosure, and FIGS. 11 and 13 show the respective guide devices 17 in a perspective illustration.

According to the embodiment according to FIGS. 10 and 11, the guide device 17 may comprise a base 123 resting on a groove base, from which base the latching parts 117 extend downward for form-fitting engagement with sill-side latching projections 119, and two lateral support arms 125 which extend upward from the base 123 and which are dimensioned in such a way that they do not project beyond a sill upper side 127 in the height direction H and terminate flush therewith. As a result, particularly good sealing in the region of the transition between the guide device 17 and the sill 10 and protection against injury to people are given. During the assembly into the running rail groove 13, 15, the support arms 125 can be pressed with a side wall 129 of the running rail groove 13, 15. In this case, an in particular elastic deformation of the support arms 125 can occur, which results in an in particular elastic deformation restoring force which improves the sealing action in the region of the transition.

According to the embodiment of the sill 10 in FIGS. 12 and 13, a cost-effective variant of the guide device 17 is shown, which manages without the projecting latching arms 125, but is otherwise designed substantially identically.

The features disclosed in the above description, the figures and the claims can be significant both individually and in any desired combination for the realization of the disclosure in the various configurations.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1 Floor bridge
3 Connecting part
5 Joint head
7 Bridging part
9 Bridging lip
10 Sill
13, 15 Running rail groove
17 Guide device
19 Sill surface
21, 23 Sill surface
25 Lateral end face
27 Web
29 Hollow chamber
31 Joint socket
33 upper side
35 structuring
37 jointing and latching mechanism
39 latching recess
41 latching projection
43 underside
45 profile web
47 latching projection
49 abutment portion
51 receptacle
53, 53′ stop surface
55, 55′ stop surface
57 jointing mechanism
61 bearing surface
63 bearing web
65 ring
67 stop projection
69 securing part
71 securing projection
73 bearing surface
75 groove
100 Sliding door and/or sliding window system
103 Carriage
105 Lifting and/or lifting sliding sash
107 Base
108 Floor covering
109 Interspace
110 Screed
111 Sash rebate
112 Guide groove
113 Sash
115 Seal
117 Latching part
119 Latching element
121 bevel
123 base
125 support arm
127 sill upper side
129 side wall
H Height direction
Q Transverse direction
V Displacement direction
R Rotation direction

1. A floor bridge for a sill for a sliding door and/or sliding window system, which has a sash and a sliding or lifting sliding sash which is movable in a displacement direction relative to the sash, the floor bridge comprising:
a connecting part with a joint head configured to attach to a lateral end face of the sill extending in the displacement direction; and
a bridging part with a bridging lip configured to bridge an intermediate space between a base or floor and the sill, and a joint socket configured to encompass the joint head to couple the bridging part and the connecting part to one another, and, in a coupled state of the bridging part and the connecting part to one another, the joint socket being rotatable relative to the joint head.

2. The floor bridge according to claim 1, wherein the joint head and the joint socket are configured such that, during a relative rotational movement, the joint socket is configured to slide along the joint head and/or is configured to be guided by the joint head during a relative rotational movement.

3. A floor bridge for a sill for a sliding door and/or sliding window system, which has a sash and a sliding or lifting sliding sash which is movable in a displacement direction relative to the sash, the floor bridge comprising:
a connecting part with a joint head configured to attach to a lateral end face of the sill extending in the displacement direction; and
a bridging part with a bridging lip configured to bridge an intermediate space between a base or floor and the sill, and a joint socket configured to be brought into engagement with the joint head to couple the bridging part and the connecting part to one another, and, in a coupled state of the bridging part and the connecting part to one another, the joint socket being rotatable relative to the joint head between two end rotational stops.

4. The floor bridge according to claim 3, wherein a free rotational angle defined by the two end rotational stops is at least 60°.

5. The floor bridge according to claim 3, wherein the two end rotational stops are formed by two pairs of mutually assigned stop faces of the connecting part and the bridging part.

6. The floor bridge according to claim 5, wherein the joint head is C-shaped in cross section and has a projection on both C limbs, the respective projections being configured to strike in each case a bearing web which forms the joint socket in sections.

7. The floor bridge according to claim 3, wherein the joint head is cylindrical, the connecting part including a web which is configured to be placed flush against an upper side of the sill and opens into the joint head.

8. The floor bridge according to claim 3, wherein the joint socket comprises a concave receptacle for the joint head, the receptacle being circular arc-shaped and/or having a central angle of more than 180°.

9. The floor bridge according to claim 8, wherein joint-socket-side stop faces are formed by the opposite ends of the concave receptacle.

10. The floor bridge according to claim 3, wherein the connecting part comprises two latching elements configured to engage with corresponding sill-side latching elements to attach the connecting part to the sill.

11. The floor bridge according to claim 10, wherein a connecting-part-side latching element of the two latching elements is configured to be grasped by at least one of the associated sill-side latching elements.

12. The floor bridge according to claim 10, wherein a connecting-part-side latching element is configured to engage behind a sill-side profile web in a transverse direction oriented transversely with respect to the displacement direction to prevent the connecting part and sill moving away from one another in the transverse direction.

13. A floor bridge for a sill for a sliding door and/or sliding window system, which has a sash and a sliding or lifting sliding sash which is movable in a displacement direction relative to the sash, the floor bridge consisting of:
a connecting part with a joint head for attaching, in particular in a form-fitting and/or force-fitting manner, to a lateral end face of the sill extending in the displacement direction, and
a bridging part with a bridging lip configured to bridge an intermediate space between a base or floor and the sill, and a joint socket configured to be brought into engagement with the joint head to couple the bridging part and the connecting part to one another.

14. A floor bridge for a sill for a sliding door and/or sliding window system, which has a sash and a sliding or lifting sliding sash which is movable in a displacement direction relative to the sash, the floor bridge comprising:
a connecting part with a joint head configured to attach to a lateral end face of the sill extending in the displacement direction; and
a bridging part including a bridging lip configured to bridge an intermediate space between a base or floor and the sill, and a joint socket, configured to be brought into engagement with the joint head to couple the bridging part and the connecting part to one another, wherein the floor bridge is configured to form a barrier-free transition between the base or floor and the sill.

15. A sill for a sliding door and/or sliding window system having a sliding or lifting sliding sash and a further sash, the sliding or lifting sliding sash being movable in a displacement direction relative to the further sash, the sill comprising:
a lateral end face extending in the displacement direction; and
a floor bridge according to claim 14, the connecting part of which being attached to the end face and the bridging part of which is in engagement with the connecting part.

16. A sliding door and/or sliding window system, comprising:
a sliding or lifting sliding sash;
a further sash, wherein the sliding or lifting sliding sash is movable in a displacement direction relative to the further sash; and
a sill according to claim 15, the sill having a running rail groove and a guide device which is configured to be accommodated completely in the running rail groove and to come into guiding engagement with a running carriage of the sliding or lifting sliding sash.

17. The sliding door and/or sliding window system according to claim 16, further comprising a latching part configured to connect to a latching element of the sill, the latching element having a corresponding shaped as the latching part.

18. The sliding door and/or sliding window system according to claim 17, wherein the sill-side latching element is a groove which is T-shaped in cross section, and the guide-device-side latching part has at least one latching projection configured to engage behind a T-limb of the groove.

19. The sliding door and/or sliding window system according to claim 17, wherein the guide-device-side latching part is dimensioned in relation to the sill-side latching element such that the guide-device-side latching part is configured to be elastically deformed when engaging an assembly end position.

20. The sliding door and/or sliding window system according to claim 17, wherein the sill comprises a base resting on a groove base, and at least one support arm which project from the base and is dimensioned for flush connection to a sill upper side.

21. The sliding door and/or sliding window system according to claim 20, wherein the at least one support arm is configured to bear sealingly against a side wall of the running rail groove.

22. A method for mounting a floor bridge on a sill for a sliding door and/or sliding window system having a sliding or lifting sliding sash and a further sash, the sliding or lifting sliding sash being movable in a displacement direction relative to the further sash, the method comprising:
fitting a connecting part in a fitting-on direction onto a lateral end face of the sill extending in the displacement direction;
bringing a bridging part into coupling engagement with the connecting part in a coupling orientation along a coupling direction; and
rotating the bridging part about a rotational axis defined by the coupling engagement into a sealing orientation to bridge an intermediate space between a base or floor and the sill.

23. The method according to claim 22, wherein the connecting part is latched when being fitted onto the sill.
